(19) United States
(12) Patent Application Publication
(10) Pub. No.: US 2006/0153964 A1
(43) Pub. Date: Jul. 13, 2006

(54) Food oil product and the use of the same

(75) Inventor: Harri Repo, Hollola (FI)

Correspondence Address: VENABLE LLP, P.O. BOX 34385, WASHINGTON, DC, 20045-9998, US

(73) Assignee: OY VEGAOILS LTD, Hollola (FI)

(21) Appl. No.: 10/538,663

(22) PCT Filed: Dec. 10, 2003
(86) PCT No.: PCT/FI03/00943

§ 371 Date: Jun. 10, 2005

(30) Foreign Application Priority Data
Dec. 10, 2002 (FI) 20022175

(51) Int. Cl. A23D 9/00

(52) U.S. Cl. 426/601

(57) ABSTRACT

A food oil product based on turnip rapeseed oil or rapeseed oil. The oil contains tocopherol antioxidant and α-lipoic acid as regenerator for the antioxidant.

The invention relates to a food oil product, which is based on turnip rapeseed oil or rapeseed oil and contains antioxidant. The invention relates especially to a turnip rapeseed-based or rapeseed-based food oil product replacing butter, margarine and flour treatment agents in baking and food processing. The invention also relates to the use of a food oil product.

Hardened turnip rapeseed oil or rapeseed oil is the healthiest vegetable fat alternative. On the basis of its composition, this vegetable oil is better than, for example, olive oil.

The problem of oil is becoming rancid, which also damages the food product containing it. Rancidity affects especially the odour and taste of the product and thus directly consumer satisfaction. This problem occurs, for example, when preserving a product for a long time. Becoming rancid is, in addition, faster if the product is kept at room temperature. There are several turnip rapeseed oil-based or rapeseed oil-based food product oils on the market, where efforts to improve rancidity prevention have been made with antioxidants.

Rancidity in food oil is a complex process, which produces reactive units, such as organic peroxides, alcohols, aldehydes, ketone compounds, and carbonylic acids. Of the many possible oxidation reactions, the most common is the formation of free radicals in the fatty acids containing a double bond, which are otherwise recommended in a diet. These free radicals bind oxygen and form a peroxide radical, which enables a chain reaction and produces organic peroxides as a main product. These peroxides transform into secondary products, such as alcohol and carbonyl compounds, which further oxidize into carboxylic acids. At the same time the tocopherols contained in the turnip rapeseed oil lose their antioxidant properties. Rancidity may take place in storage conditions, but especially the fats in food oil are exposed to becoming rancid in connection with use and when the oil is in a finished food product, because these situations involve a high temperature and a oxygenous environment. Thus, the quality of the food oil has a crucial effect on the quality of the food product manufactured by means of it, especially pastries.

The existing known product solutions use propyl gallate, butyl hydroxy anisole (BHA), butyl hydroxy toluene (BHT), or ascorbic acid or some of their compounds as antioxidants. Lecithin emulgator is generally used as emulgators. Mixtures formed in different hardened fats, part of which include enzymes, are used as flour enhancers.

Synthetic antioxidants, such as butyl hydroxyl anisole (BHA) and butyl hydroxy toluene (BHT), may cause unwanted side effects if their recommended daily dosage is exceeded. Indeed, this has caused an even growing interest in natural antioxidants.

The purpose of the invention is to remove the problems connected to especially the preservability of a product and a food product manufactured by means of the product, and to provide a food oil product containing double bond fatty acids, which remains unrancid significantly longer than the present products, and which is based on natural antioxidants. The natural antioxidants here refer to antioxidants, which can be found in nature but which can either originate in natural materials or be manufactured synthetically.

A purpose of the invention is also to provide a multifunctional pumpable and unhardened unrancid turnip rapeseed oil-based or rapeseed oil-based food oil containing unsaturated fats (triglycerides), which can be used in food product manufacture as the oil remaining in the food product, especially in baking as the baking oil.

To attain this purpose, the product according to the invention is primarily characterized in that it contains α-lipoic acid as regenerator for the antioxidant. The alpha-lipoic acid is significant especially from the point of view of the preservability of a product manufactured by means of the food oil, because it retains the effect of tocopherol antioxidants and prevents rancidity for a long time in a finished product.

With a system of additives according to an advantageous embodiment, it is possible to create the first pumpable, unhardened fat containing vegetable oil product, which comprises turnip rapeseed oil and/or rapeseed oil as a base, as well as tocopherol as antioxidant, lecithin (E322) as emulgator, mono and diglycerides of fatty acids (E471), acetic acid esters of the mono and diglycerides of fatty acids (E472a) or sucrose esters of fatty acids (E473); for acidity regulation it is possible to use citric acid (E330); alpha-lipoic acid is used as the regenerator for the tocopherol mixture (E306) used as antioxidant, enzymes capable of splitting the organic long chain components of the raw material of the food product (flour in the case of baking) are used as enzymes, such as amylase and/or pentosanase and possibly hemicellulose, which can be, for example Aspergillus niger, Trichoderma longibrachiatum and Aspergillus oryzae-based enzymes, in order to bring about the lightness of the structure of a bakery good and to improve durability of sub-zero storage. With said enzyme addition, it is possible to replace the separately added enzyme-containing flour enhancers, and thus the product is especially suitable for yeast doughs (doughs raised with yeast) and frozen doughs. Aromas, if they are used, are selected according to necessity from the group of fat-soluble aromas. It is possible to use, for example, butter aroma.

With a suitable system of additives it is thus possible to improve the multifunctionality. When one or more enzymes are used, a pumpable and unhardened unrancid turnip rapeseed oil-based or rapeseed oil-based baking oil containing non-saturated fats (triglycerides) is provided, which at the same time acts as flour enhancer thus replacing the conventional flour enhancers added as powders or as other separate dosage. This type of baking oil containing one or more enzymes is also suitable for manufacturing frozen doughs. When butter aroma is used in the product, in addition to the above, a baking oil is provided, which at the same time provides a butter aroma to the finished baked product. It is also possible to use some other fat-soluble aroma, if some other specific aroma is wanted for the finished product. Butter aroma or some other fat-soluble aroma can also be used without enzymes.

In the following, the invention will be described more in detail by means of some examples, which do not restrict the invention.

All the products were made in a turnip rapeseed base. The main raw material of the oil was turnip rapeseed oil pressed out without chemicals by Mildola Oy. The natural tocopherol level of oil was approx. 25 mg/kg. Examples of the products are presented in the following table (amounts as percentages of weight).

| | 1 | 2 | 3 | 4 | 5 | 6 | 7 |
|---|---|---|---|---|---|---|---|
| Raffinated turnip | 98.613 | 99.288 | 98.788 | 98.719 | 96.839 | 96.539 | 96.439 |
| rapeseed oil or rapeseed | | | | | | | |
| oil | | | | | | | |
| Lecithin soy/turnip rape | 1.325 | 0.650 | — | — | — | — | — |
| E 473 | — | — | 1.150 | — | — | — | — |
| E 472a | — | — | — | 0.200 | 0.150 | 0.180 | 0.180 |
| E 472e | — | — | — | 1.000 | 1.000 | 2.000 | 2.000 |
| Alpha-tocopherol | 0.002 | 0.002 | 0.002 | 0.003 | 0.003 | 0.003 | 0.003 |
| Gamma-tocopherol | 0.015 | 0.015 | 0.015 | 0.023 | 0.023 | 0.023 | 0.023 |
| Delta-tocopherol | 0.010 | 0.010 | 0.010 | 0.015 | 0.015 | 0.015 | 0.015 |
| Citric acid | 0.020 | 0.020 | 0.020 | 0.020 | 0.020 | 0.020 | 0.020 |
| Alpha-lipoic acid | 0.015 | 0.015 | 0.015 | 0.020 | 0.020 | 0.020 | 0.020 |
| Pentosanase/alpha- | — | — | — | — | 1.045 | 1.045 | 1.045 |
| amylase enzyme | | | | | | | |
| Hemicellulose/amylase | — | — | — | — | 0.885 | — | — |
| enzyme | | | | | | | |
| Alpha-amylase enzyme | — | — | — | — | — | 0.155 | 0.155 |
| Butter aroma | — | — | — | — | — | — | 0.100 |

In product 1, soybean lecithin is used as an emulgator and in product 2 turnip rapeseed lecithin. In product 3, the emulgator is sucrose esters of fatty acids (E473). In products 4 to 7, the emulgator is a mixture of acetic acid esters and the mono and diacetyl tartaric acid esters of mono and diglycerides of fatty acids (E472a+E472e), in products 5 to 7 alpha-amylase and pentosanase are used as enzyme additions, and in product 5 in addition to these also hemicellulose/amylase enzyme (pentosanase/alpha-amylase: Nutrilife CS 16, hemicellulose/amylase: Nutrilife k-FQ10, alpha-amylase: Nutrilife AM17, all produced by Grünau Illerliseen GmbH), and in product 7, butter aroma is used. All products are provided with a mixture of alpha, gamma and delta-tocopherol as antioxidant (more in products 4 to 7) and alpha-lipoic acid as the regenerator of tocopherol antioxidant (more in products 4 to 7). All products are also provided with citric acid (E330) as pH controller and catcher of metal ions. The amount of tocopherols is stated as the tocopherol added to the product in the table, and it is to be noted that in addition to these, it also includes natural tocopherol from the turnip rapeseed oil base. The added tocopherol mixture contains typically 5 to 10 weight-% of alpha-tocopherol, 40 to 65 weight-% of gamma-tocopherol and 25 to 55 weight-% of delta-tocopherol. This type of a tocopherol mixture is added advantageously so much, that the total tocopherol of the product (including the inherent one in the oil) is at least 0.02 weight-%.

The added synthetic tocopherol is sensitive and acts as a fast antioxidant. It is advantageous that the added synthetic tocopherol is a mixture of at least gamma and delta-tocopherol.

In addition, the sucrose esters of fatty acids have the effect that they create a brown colour when heated, which can be desirable in baking, because in this way the brown/brownish colour on the surface of pastries can be provided without sugar addition.

The enzymes are well protected in the oil, and they begin to act in the food product environment when they come into contact with the components contained in the flour. Therefore, flour enhancers are not necessary to be added separately in baking. When the product containing enzymes is used in manufacturing frozen dough, it can compensate for the decrease in the activity of the yeast contained in the dough during freezing.

The effect of antioxidants can still be increased by means of ascorbic acid. If the product is provided with ascorbic acid, it improves the effect of alpha-lipoic acid in water environment, i.e. it prevents the food oil from becoming rancid in a food product containing water. Thus, the effect of the ascorbic acid begins when the food oil comes into contact with the water contained in the raw material of the food product, for example when adding food oil into a dough during baking. Thus, it is possible to prevent the rancidity of the actual food product with ascorbic acid.

The ascorbic acid is advantageously added when dissolved in a carrier substance, which, being fat-soluble, can distribute the ascorbic acid homogeneously into the food oil product. Thus, it is possible to use the natural water-soluble ascorbic acid without resorting to fat-soluble ascorbic acid derivates. The carrier substance is short chain alcohol, advantageously propylene glycol or ethanol. More advantageously the substance is propylene glycol (propane-1,2-diole), which is approved in the EU as a carrier substance used in food products (E code E1520), and which has a high flash point. The carrier substance, where the ascorbic acid is in a concentration of 15 to 30 weight-%, can be added to the food oil product by the amount that corresponds to the desired concentration of the ascorbic acid in the oil product. The concentration can be, for example, 0.02 to 0.2 weight-%, advantageously 0.05 to 0.1 weight-% of the product weight. The fat-soluble antioxidant provided in this way acts already in the oil phase advantageously by significantly decreasing the rancidity tendency of the food oil product containing non-saturated fats. The use of ascorbic acid in vegetable oils, such as turnip rapeseed oil, is described more in detail in the inventor's Finnish patent application 20031190, which is incorporated herein by reference.

If the emulgator is turnip rapeseed lecithin, it is possible to increase the antioxidant effect of tocopherols further with it. In addition, turnip rape lecithin is allergy-free. The added lecithin is advantageously hydrolysed lecithin. The turnip rapeseed oil contains inherent lecithin as well, and with the addition, the lecithin content is increased to the desired level.

The task of the turnip rapeseed or rapeseed oil component it to function as the carrier substance of all other components, and it is composed in a known manner mainly of triglycerides of long chain fatty acids, and it contains triglycerides of non-saturated fatty acids. The amount of oil component is generally at least 95 weight-%.

The product 2 of the above-mentioned table and known food oil products were tested in the tests.

Testing the oil samples was performed with the Rancimat 743 device, which is manufactured by Metrohm Ltd., Switzerland. The method used is generally called the “Rancimat method” (Laubli, M. W and Bruttel, P. A. Determination of the oxidative stability of fats and oils; comparison between the active oxygen method (AOCS Cd 12-57) and the rancimat method. J. Am. Oil Chem. Soc. 63: 792-795 (1986)).

In the test, 6 grams of the samples were weighed to the reaction vessel, and the samples were heated to 120° C. A continuous air flow at a rate of 20 l/h was directed to the samples. Electroconductivity was measured from the test vessels, into which 60 mL of distilled water has been dosed.

Of the results it can be stated that with the above-mentioned antioxidant packet a result 61.7 h was received in the Rancimat-test, which is almost on the same range as the hydrogenated (not containing double bonds) turnip rapeseed oil raffinates (Akorex, Karlshamn). On the other hand, when performing the same tests on known turnip rapeseed oil products containing antioxidants, values of 1.0 to 18.2 h were received. When the concentration of the antioxidant packet (tocopherols and alpha-lipoic acid) was reduced to a half of the above-described concentration in product 2, a value of 56.6 h was still reached.

The effect of alpha-lipoic acid best becomes apparent by comparison with a product where 0.024 weight-% of synthetic tocopherol mixture without alpha-lipoic acid is added to the turnip rapeseed base: the value was only 17.0 h, even though the amount of tocopherol was on the same level.

The products according to the invention can be used as liquid, pumpable baking oils replacing baking margarines and butter. The baking oil can be used in a dough in an amount of 1 to 15 weight-% of the fresh weight of the dough. When a product containing enzymes is used as baking oil and it is used to make frozen dough, its amount is 0.5 to 2.0 weight-%, typically approximately 1.0 weight-% of the fresh weight of the dough.

The oil according to the invention is especially suitable to be added as baking oil to yeast doughs when baking rolls, buns and breads, but the invention is not limited to these.

In addition, the invention is not limited to only baking, but it can be used in manufacturing other food products as well, especially in situations where the oil comes into contact with water in the food product and heating is involved in the manufacturing process.

1-9. (canceled)

10. A food oil product, comprising:
turnip rapeseed oil or rapeseed oil;
tocopherol antioxidant; and
α-lipoic acid as regenerator for the antioxidant.

11. The product according to claim 10, wherein the tocopherol antioxidant comprises added synthetic tocopherol.

12. The product according to claim 11, wherein the tocopherol antioxidant comprises at least gamma and delta tocopherol.

13. The product according to claim 10, comprising at least 0.02 weight-% of tocopherol and at least 0.002 weight-% of alpha-lipoic acid.

14. The product according to claim 11, comprising at least 0.02 weight-% of tocopherol and at least 0.002 weight-% of alpha-lipoic acid.

15. The product according to claim 10, further comprising:
turnip rapeseed lecithin.

16. The product according to claim 11, further comprising:
turnip rapeseed lecithin.

17. The product according to claim 10, further comprising:
ascorbic acid.

18. The product according to claim 11, further comprising:
ascorbic acid.

19. The product according to claim 14, further comprising:
ascorbic acid.

20. The product according to claim 16, further comprising:
ascorbic acid.

21. The product according to claim 10, further comprising:
enzyme.

22. The product according to claim 11, further comprising:
enzyme.

23. The product according to claim 18, further comprising:
enzyme.

24. The product according to claim 19, further comprising:
enzyme.

25. The product according to claim 20, further comprising:
enzyme.

26. The product according to claim 21, wherein the enzyme comprises amylase, pentosanase and/or hemicellulase.

27. Use of a product according to claim 10 in manufacturing a food product in baking.

28. Use of a product according to claim 11 in manufacturing a food product in baking.

29. Use of a product according to claim 17 in manufacturing a food product in baking.

30. Use of a product according to claim 18 in manufacturing a food product in baking.

31. Use of a product according to claim 19 in manufacturing a food product in baking.

32. Use of a product according to claim 20 in manufacturing a food product in baking.

33. Use of a product according to claim 10 in manufacturing a food product in such a manner that it becomes in contact with the water contained in the food product during heating.

34. Use of a product according to claim 11 in manufacturing a food product in such a manner that it becomes in contact with the water contained in the food product during heating.

35. Use of a product according to claim 17 in manufacturing a food product in such a manner that it becomes in contact with the water contained in the food product during heating.
